(19) United States
(12) Patent Application Publication
(10) Pub. No.: US 2006/0095662 A1
(43) Pub. Date: May 4, 2006

(54) Method and computer program product for displaying and modifying hardware status

(75) Inventor: Randy M. Arnott, Mont Vernon, NH (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 10/977,942

(22) Filed: Nov. 1, 2004

(51) Int. Cl. G06F 12/00

(52) U.S. Cl. 711/114; 711/170

(57) ABSTRACT

A method and related computer program product for operating a computer system which in a preferred embodiment comprises, acquiring a digital image of a hardware element, storing the digital image, displaying the digital image in a software program and dynamically updating and displaying status information for hardware elements proximate to the digital image and allowing the user to dynamically change element status by interacting with the displayed image.

### BACKGROUND OF THE INVENTION

1. Field of the Invention

This invention relates generally to visual status displays and control interfaces for computer hardware, and in more specific embodiments, to displaying and modifying the status of one or more drives in a RAID array.

2. Background Art

There are many applications, particularly in a business environment, where there are needs beyond those that can be fulfilled by a single hard disk, regardless of its size, performance or quality level. Many businesses can't afford to have their systems go down for even an hour in the event of a disk failure. They need large storage subsystems with capacities in the terabytes. And they want to be able to insulate themselves from hardware failures to any extent possible. Some people working with multimedia files need fast data transfer exceeding what current drives can deliver, without spending a fortune on specialty drives. These situations require that the traditional “one hard disk per system” model be set aside and a new system employed. This technique is called Redundant Arrays of Inexpensive Disks or RAID. (“Inexpensive” is sometimes replaced with “Independent”, but the former term is the one that was used when the term “RAID” was first coined by the researchers at the University of California at Berkeley, who first investigated the use of multiple-drive arrays in 1987. See D. Patterson, G. Gibson, and R. Katz. “A Case for Redundant Array of Inexpensive Disks (RAID)”, Proceedings of ACM SIGMOD '88, pages 109-116, June 1988.

The fundamental structure of a RAID is the array. An array is a collection of drives that is configured, formatted and managed in a particular way. The number of drives in the array, and the way that data is split between them, is what determines the RAID level, the capacity of the array, and its overall performance and data protection characteristics.

A number of RAID levels are known. JBOD stands for Just a Bunch of Drives. The controller treats one or more disks or unused space on a disk as a single array. JBOD provides the ability to concatenate storage from various drives regardless of the size of the space on those drives. JBOD is useful in scavenging space on drives unused by other arrays. JBOD does not provide any performance or data redundancy benefits.

RAID0, or striping, provides the highest performance but no data redundancy. Data in the array is striped (i.e. distributed) across several physical drives. RAID0 arrays are useful for holding information such as the operating system paging file where performance is extremely important but redundancy is not.

RAID1, or mirroring, mirrors the data stored in one physical drive to another. RAID1 is useful when there are only a small number of drives available and data integrity is more important than storage capacity.

RAID1n, or n-way mirroring, mirrors the data stored in one hard drive to several hard drives. This array type will provide superior data redundancy because there will be three or more copies of the data and this type is useful when creating backup copies of an array. This array type is however expensive, in both performance and the amount of disk space necessary to create the array type.

RAID10 is also known as RAID(0+1) or striped mirror sets. This array type combines mirrors and stripe sets. RAID10 allows multiple drive failures, up to 1 failure in each mirror that has been striped. This array type offers better performance than a simple mirror because of the extra drives. RAID10 requires twice the disk space of RAID0 in order to offer redundancy.

RAID10n stripes multiple n-way mirror sets. RAID10n allows multiple drive failures per mirror set, up to n−1 failures in each mirror set that has been striped, where n is the number of drives in each mirror set. This array type offers better random read performance than a RAID10 array, but uses more disk space.

RAID5, also known as a stripe with parity, stripes data as well as parity across all drives in the array. Parity information is interspersed across the drive array. In the event of a failure, the controller can rebuild the lost data of the failed drive from the other surviving drives. This array type offers exceptional read performance as well as redundancy. In general, write performance is not an issue due to the tendency of operating systems to perform many more reads than writes. This array type requires only one extra disk to offer redundancy. For most systems with four or more disks, this is the correct choice as array type.

RAID50 is also known as striped RAID5 sets. Parity information is interspersed across each RAID5 set in the array. This array type offers good read performance as well as redundancy. A 6-drive array will provide the user with 2 striped 3-drive RAID5 sets. Generally, RAID50 is useful in very large arrays with 10 or more drives.

If a disk drive or multiple disk drives are connected to and controlled by a RAID controller, then they are collectively referred to as a “RAID array”. A disk drive previously configured by the operating system of a computing device and then connected to a RAID controller is referred to as a “legacy drive”. After the legacy drive is configured by the RAID controller its is referred to as a “legacy array”. If a new drive which was not configured by the RAID controller or the OS is attached to the RAID controller, then the drive is referred to as an “un-initialized drive”. The drive is converted into an initialized RAID drive after the RAID controller writes its unique configuration data to that disk.

Thus RAID or Redundant Array of Independent Disks are simply several disks that are grouped together in various organizations to either improve the performance or the reliability of a computer's storage system. These disks are grouped and organized by a RAID controller. The user interacts with RAID controller software to configure disks and their RAID levels in the RAID array. The arrays can be configured to any of the RAID levels RAID 0, RAID 5, RAID 1 etc. as mentioned above.

Besides RAID arrays, computer systems have multiple hardware elements such as motherboard, audio and video cards, memory chips etc. If one of these elements fails and needs to be replaced or needs maintenance, firstly, the user may not be aware of the faulty status of that hardware element and secondly, the user may have difficulty identifying the responsible hardware element amongst other hardware elements present in the system.

There is a need for improvement in communicating status and fault information for hardware elements in a computer system to persons who use and maintain the computer system.

### BRIEF SUMMARY OF THE INVENTION

Additional features and advantages of the invention will be set forth in the description that follows, and in part will be apparent from the description, or may be learned by practice of the invention.

In preferred embodiments, the invention comprises a method and related computer program product for operating a computer system which comprises acquiring a digital image of a hardware element, storing the digital image, and displaying the image in a software program. The display preferably provides hardware status information in connection with the digital image, dynamically updates and displays the hardware status information, and allows the user to dynamically control the hardware element's operation by interacting with the displayed image.

It is to be understood that both the foregoing general description and the following detailed description are exemplary and explanatory and are intended to provide further explanation of the invention as claimed. The description herein is not intended to limit the scope of the claimed invention in any way.

### BRIEF DESCRIPTION OF FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block schematic diagram of a computer system comprising a RAID controller and a RAID array.

FIG. 2 is a diagram of a digital image of the disk enclosure and disk drives from FIG. 1.

FIG. 3 is a diagram of a digital image of a disk enclosure and disk drives with status information displayed as part of the image, illustrating one embodiment of the invention.

FIG. 4 is a screen display showing an exemplary implementation of the embodiment of FIG. 3.

FIG. 5 illustrates a plurality of individual digital images of the disk drives from FIG. 1.

FIG. 6 is a diagram showing a digital display comprising a plurality of digital images of hardware elements, according to a further embodiment of the invention.

FIG. 7 illustrates one embodiment of a status information box that can be associated with digital images of hardware elements to provide a status display.

FIG. 8 illustrates a disk enclosure with status indicating LEDs.

FIG. 9 illustrates a RAID controller card having status indicating LEDs.

FIG. 10 is a block diagram of a general purpose computer system providing an example of a system for which the present invention can be implemented.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The present invention will be described in terms of an embodiment applicable to the display of status information relating to one or more computer disk drives, and in particular, a RAID array, and to the interactive control of those hardware elements through a visual display. It will be understood that the essential display and control concepts disclosed herein are applicable to a wide range of electronic systems, architectures and hardware elements. Thus, although the invention will be disclosed and described in terms of providing RAID status and control functions, the invention is not limited to this field.

A conventional RAID controller can manage many disk drives and large databases have multiple RAID controllers resulting in a large number of disk drives. The inventor has identified a number of problems with traditional control software for these RAID controllers. In conventional designs there may or may not be a visual display of the hardware configuration, and there is no visual mapping between the physical RAID configuration and the logical RAID configuration shown by the RAID software. For example, assume that the RAID software is used to configure four disks as a RAID level 10 array, and three disks as a RAID level 5 array. In the event that the third disk belonging to RAID level 10 undergoes failure or needs maintenance, it is difficult to visually identify the location of the responsible physical hard drive in the system. This is because in the physical RAID configuration the drives may not be arranged in the same order as their logical configuration in the RAID software. Thus, users may need to know how their disks are organized, both in the RAID software and in their corresponding physical location. In cases where there is more than one logical array, the user also needs to know which physical disks are associated with which RAID arrays in software and be able to identify the physical disks by visually inspecting the RAID configuration in software. The user may also not be aware of a faulty drive in the array and needs a software indicator to identify the responsible drive. Some storage systems provide a fixed set of supported physical configurations and a fixed mapping between software RAID configurations and the physical RAID configurations. However, this method does not provide the user with any flexibility to modify the physical or software RAID configuration.

A general-purpose RAID controller can be used in an unlimited number of environments. A typical RAID controller has no fixed physical or software RAID array configurations. In a first embodiment of the present invention, the user may store an actual digital image of hardware elements (e.g. disks in a RAID array), configure control and/or status display software to use that image of hardware elements, and then configure status information for the hardware elements to be displayed proximate to the uploaded image. In one preferred embodiment, status information for each hardware element, for example a disk, is overlaid on the digital image of those disks and the information is updated dynamically as system status changes. In this manner, the user is provided with a visual display of current status information for each drive in the array. The user can also interact with the displayed information to control the array. In particular, the user can click on regions in the display, such as a status information region proximate to a hardware element, and select functions from a menu displayed in response to the click, to provide control inputs for the hardware elements and the array.

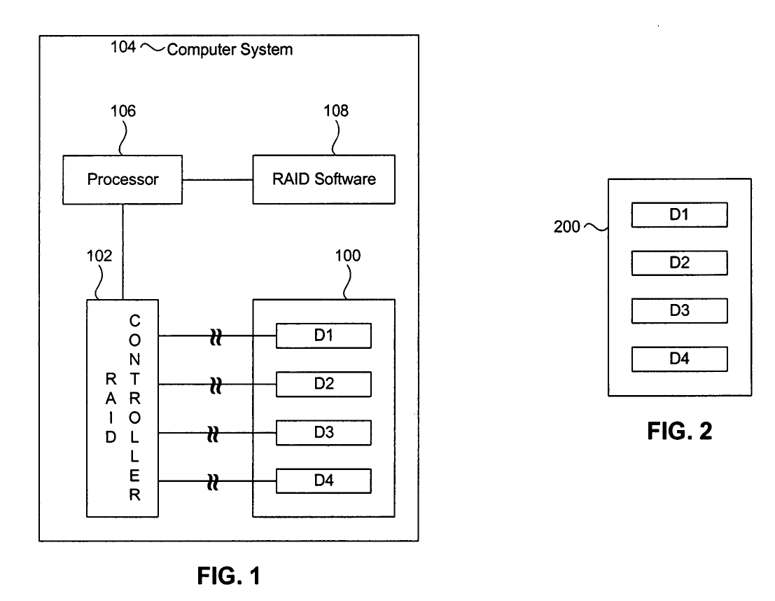

FIG. 1 is a block schematic diagram showing a computer system 104, a processor 106, RAID controller software 108 and a RAID controller 102 connected to four disk drives D1 to D4 in a disk enclosure 100. Disks D1 to D4 are controlled by RAID controller 102 and comprise a RAID array. The user interacts with RAID controller software 108 installed in computer system 104 and controlled by processor 106. The RAID software is used to configure the disks and their RAID level. As an example, disks D1 and D2 may be configured to RAID level 5 and D3 and D4 may be configured to RAID level 1.

If the RAID configuration needs to be modified by removing a physical disk, changing the physical position of a disk or replacing a disk, it is desirable for the user to know the physical location of the disk and its associated RAID level configuration in software. In addition, if one of the disks in the array undergoes failure or needs maintenance, it is desirable for RAID controller software 108 to provide an indication of the failure or maintenance requirement. After identifying a drive with reference to software 108, the user should be able to identify a corresponding disk in the physical layout of the RAID array. Although the examples presented herein have four drives in the array for simplicity, many computer systems contain a larger number of drives. With the logistics of managing a large number of drives, it becomes difficult for the user to identify which disks in the physical RAID array configuration belong to which RAID level configuration in software. The user should be able to identify which disks in the physical array correspond to disk drives in software.

FIG. 2 illustrates a digital image 200 of the disk enclosure 100 containing disk drives D1 to D4. Digital image 200 can be acquired by a digital camera or equivalent means and may be, for example, a JPEG, GIF, or other standard image data file. Preferably image 200 is an actual image of the hardware elements involved. However, further embodiments, image 200 may be a stock digital image selected from a library of images provided for this purpose (that is, an image of the hardware type rather than the actual units present in the system), or a graphic representation of the hardware element. Digital image 200 is stored in the computer system via a computer link such as the Internet, a USB port, parallel port, wireless interface, or any other link. The image can then be formatted and edited by the user as required.

### EXEMPLARY EMBODIMENT

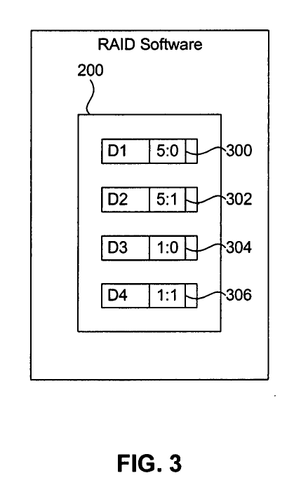

FIG. 3 illustrates an exemplary embodiment of the invention. The figure illustrates one embodiment of a display provided by RAID controller software 108 as viewed by a user on a computer screen. RAID controller software 108 displays the uploaded digital image 200 of the disk enclosure 100 containing RAID array drives D1 to D4.

In a preferred embodiment, a status display configuration mode is provided by RAID controller software 108, and in this mode the user can load one or more hardware images, re-position status information boxes, and change the image to correspond to any changes in the physical or software RAID configuration. Thus, the user can configure each status information box 300, 302, 304 and 306 and then drag and drop the box to a suitable position associated with the corresponding disk drive. In the present embodiment, the status information for each disk in the array displays the RAID level that the drive belongs to e.g. RAID 0, RAID 1 etc., along with the drive number for that RAID level configuration. In the example above, D1 is the first drive in a RAID level 5 array and D4 is the second drive in a RAID level 1 array. The status information for D1, since it belongs to the RAID level 5 array and is the first disk in that array, will be displayed as 5:0 in status information box 300. Similarly for D4 which belongs to a RAID level 1 and is the second disk in the RAID level 1 array, the status information is displayed as 1:1 in status information box 306. These status information displays are described as examples and are not intended to be exhaustive; a variety of status displays other than displaying the RAID level and the drive number for that RAID level configuration are possible within the scope of the invention. In particular, in other embodiments, the status information can be configured to display any information available to the RAID controller software about a disk in the RAID array.

Besides viewing the disk status information for all the disks in the array, the status information boxes can also be used to control operation and/or modify the status of each disk in the array. In a preferred embodiment, by right clicking on the status information box 300, the user causes display of a menu that allows the user to select from among various status control functions relating to disk D1. For example, disk D1 can be assigned as a dedicated spare or as a global spare, made accessible to the operating system, or hidden from the operating system. The status information boxes can also be used to activate light emitting diodes (LEDs) on disk enclosures and/or on RAID controllers associated with the array, as will be discussed in detail later in the application. The functions that can be accessed by clicking on the status information box are not limited to the examples given herein, but can include control of any hardware, software or configuration attribute that can be set through the RAID controller software.

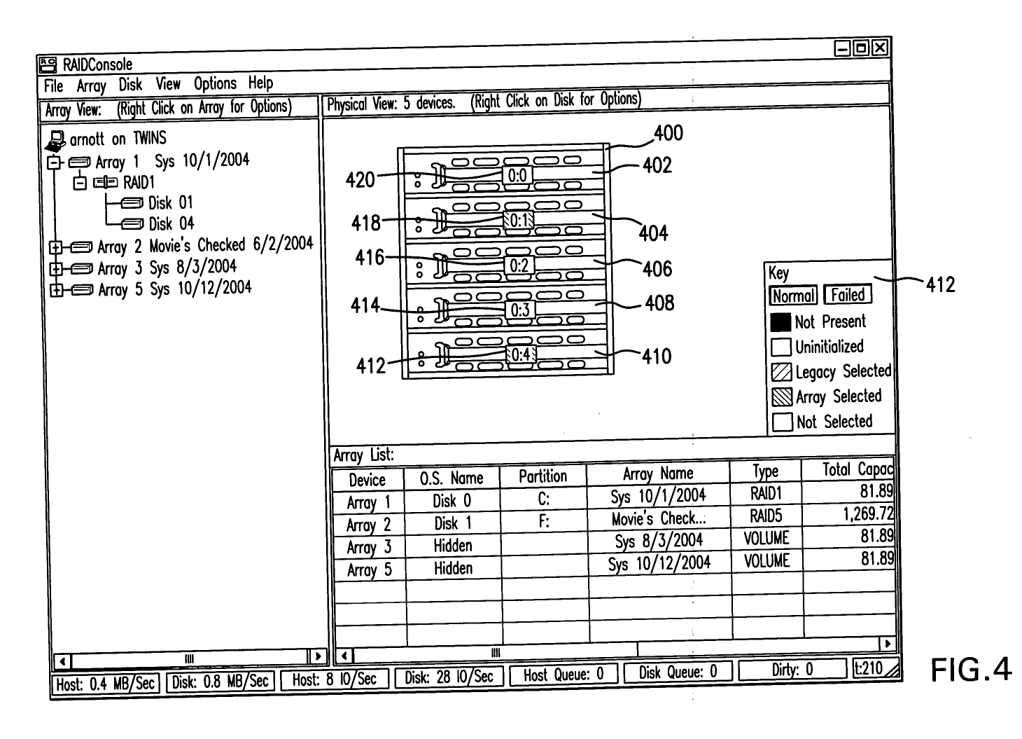

FIG. 4 illustrates a screen shot of an exemplary implementation of the RAID software embodiment that has been described generally with reference to FIG. 3. In this embodiment, a digital image 400 of a disk enclosure containing five disks 402, 404, 406, 408 and 410 is provided as a data file accessible by the RAID controller software. The five disks 402, 404, 406, 408 and 410 have corresponding status information boxes 420, 418, 416, 414 and 412 placed near them so that the user can visually associate a disk and its status information box. In this example, all the disks in the array belong to a RAID level 0 array. The five disks are numbered from 0 to 4. Thus, for example, the status information for the fourth disk in the RAID level 0 array is displayed as 0:3 in status information box 414. Assuming that the software indicates that the fourth disk in the RAID level 0 array needs to be replaced, by viewing the image the user can easily identify where that disk is physically located in the disk enclosure. The display also provides a color key 422 indicating the status conveyed by particular background colors and foreground text colors of the status information boxes, as will be discussed in greater detail later in the application.

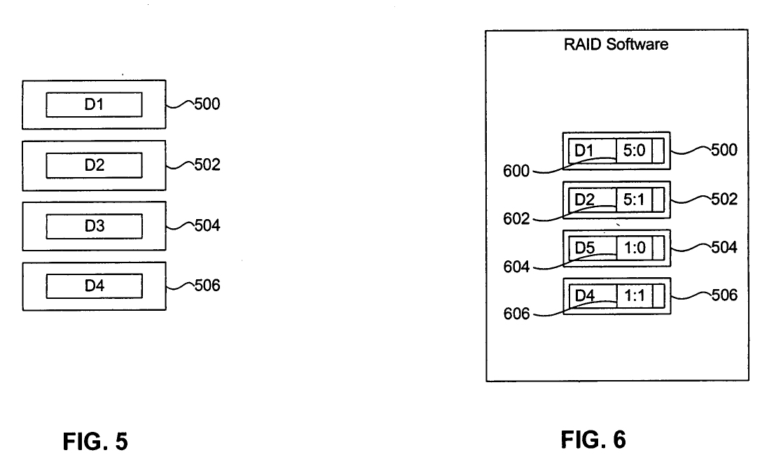

FIG. 5 illustrates individual digital images 500, 502, 504 and 506 of disk drives D1, D2, D3 and D4 from disk enclosure 100. Digital images 500, 502, 504 and 506 can be acquired by a digital camera or equivalent means and may be, for example, JPEG, GIF, or other standard image data files. Preferably these images are actual images of the hardware elements involved. However, in another embodiment, images 500, 502, 504 and 506 are stock image selected from a library of images provided for this purpose. If a library is provided, the user can manually select images for display, or software 108 may automatically select appropriate images based on available system information regarding the hardware installed. The digital images are stored in the computer system via a computer link such as the Internet, a USB port, parallel port, wireless interface, or any other link. The images are then formatted and edited by the user if required.

FIG. 6 illustrates another embodiment of the invention having individual images 500, 502, 504 and 506 of each disk in the RAID array from FIG. 5 rather than a single image of a plurality of drives as shown in the embodiment of FIGS. 3 and 4. In this embodiment, individual images of each disk in the array from FIG. 5 are stored in the system. In another embodiment, a single image is provided for a type of disk and that image is replicated in the display for each disk of that type present in the system. The user can configure each of the status information boxes 600, 602, 604 and 606 and then drag and drop each box to a suitable position proximate the corresponding disk drive. This embodiment provides the user with flexibility to move the image of a disk if its physical location is modified, rather than acquiring another digital image of the new physical layout, storing it and reconfiguring the status information. As in the previous embodiment, the user can also move the status information boxes to match any changes in the physical configuration of the RAID array. The user also has access to the same functionality as presented in the embodiment of FIG. 3, that is, the user can view the dynamically updated status of each disk in the array and dynamically control functions and operating status of a disk as desired.

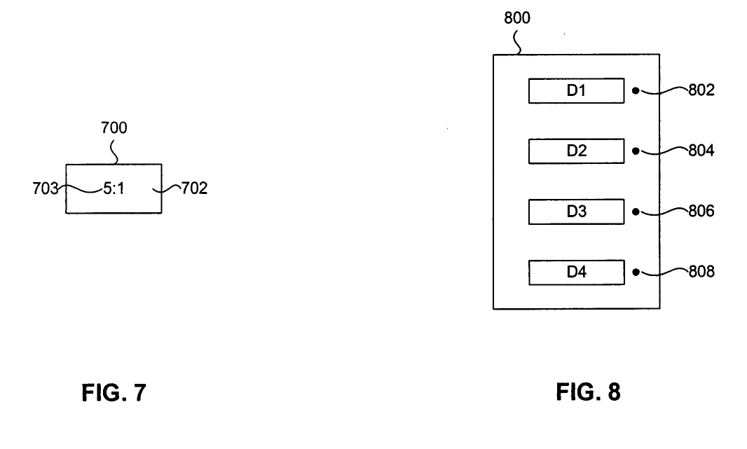

FIG. 7 illustrates one embodiment of an overlaid status information box in further detail. In the embodiments presented in FIGS. 3, 4 and 6, the status information associated with hardware element images is in one or more boxes 700. In an embodiment, boxes 700 have a background color 702 that is dynamically updated by the RAID controller to reflect changes in the status of a disk in the RAID array. Color of the foreground text 703 can also be dynamically updated by the RAID controller software to reflect changes in the corresponding disk in the RAID array. In the embodiments presented, the background color 702 of the overlaid status information is used to indicate the type of drive and whether the drive is selected or not. A green background indicates a selected RAID array drive, blue indicates a selected legacy drive, white indicates an unselected drive, grey indicates an un-initialized drive and black indicates that no drive is connected to that drive connector on the RAID controller.

As explained in the embodiments above, in this example the foreground text indicates the RAID level the drive belongs to along with the drive number for that particular configuration. Black foreground text is used to indicate a normally functioning drive and red foreground text is used to indicate a malfunctioning or failed drive. In this example, if the first drive in the RAID level 5 array (i.e. D1) undergoes failure, the status information (i.e. 5:0) will be displayed in red. The key 422 helps the user associate the background and foreground text colors with the currently displayed drive status colors. It is noted that the choice of color and information displayed is arbitrary and can be modified by a person skilled in the relevant art(s) within the scope of the invention. The embodiments use a box to display the overlaid status information, however, the geometric shape, if any, used to display the status information is arbitrary and can also be modified.

If a drive in the array undergoes failure or needs maintenance, the status information box in RAID controller software 108 preferably indicates the condition of the drive by changing the relevant background or foreground color. FIG. 8 illustrates a disk enclosure 800 containing RAID array disk drives D1, D2, D3 and D4 and their corresponding LEDs 802, 804, 806 and 808. In an embodiment, RAID controller software 108 allows the user to selectively activate LEDs 802, 804, 806 and 808 corresponding to a desired drive, such as a drive that requires maintenance, thus helping to identify a physical location of a particular disk drive by visual inspection of the physical RAID array. This can be accomplished, as one example, by the user clicking on the status information box and selecting “LED on” from a menu displayed in response to the click. A similar process is of selecting “LED off” from a menu is used to de-activate the LED. If a drive is not faulty or in need of maintenance and needs to be replaced or identified for other purposes, the user can still activate the corresponding LED using the status information box. In another embodiment, when a drive is malfunctioning or needs maintenance, the corresponding LED is automatically activated by the RAID software. In a preferred embodiment the LED blinks to help draw attention to the drive in question. In large RAID arrays having numerous disk drives this feature is particularly useful in identifying a drive requiring attention.

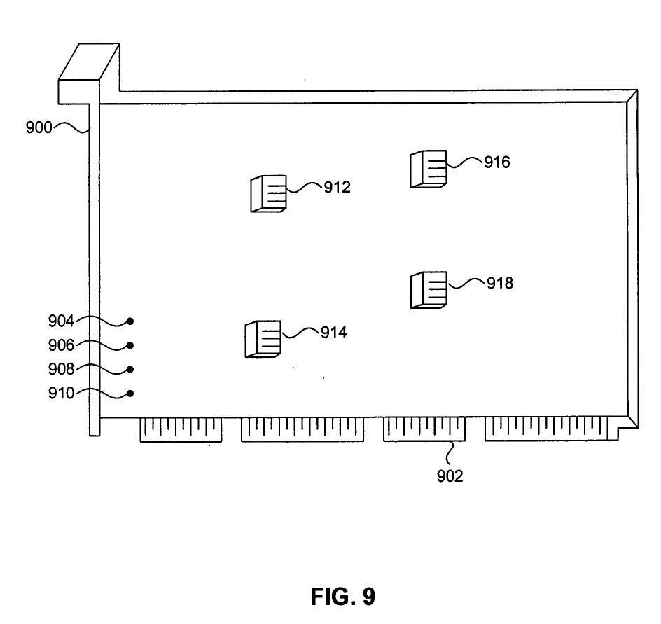

FIG. 9 illustrates a RAID controller card. A bracket 900 is used to install the card in the housing of a computer system, an edge connector 902 is used to interface the board with a corresponding slot in the computer system, and LEDs 904, 906, 908 and 910 on the RAID controller card correspond to disk drive connectors 912, 914, 916 and 918 respectively. If the user needs to identify a drive in the array, they can click on the corresponding status information box to activate the LED in the manner described above. The LED blinks allowing the user to easily identify the corresponding device. The LEDs can also be used in manufacturing tests by configuring the software to display a sequence which checks the card's functionality. In another embodiment, the LED does not blink. It will be apparent to a person skilled in the relevant art(s) that other indicators, visual or otherwise can be provided in association with a hardware device and controlled by the RAID controller software 108 or other control software to indicate the location of a hardware element for which an image is displayed by that software. It will also be apparent to a person skilled in the relevant art(s) that the LEDs can be placed in different locations either on the RAID controller card or on the disk enclosure to indicate the position of the desired disk drive in the RAID array.

The embodiments presented above are related to RAID controllers and RAID arrays, but it will be apparent to a person skilled in the relevant art(s) that the invention encompasses displaying an image of any hardware element and using that displayed image to indicate and/or control the status of the corresponding hardware element. Since the user can tailor the software view either by moving the overlaid status information or by moving individual images, an unlimited number of configurations can be achieved for any physical layout of hardware elements based on user preference.

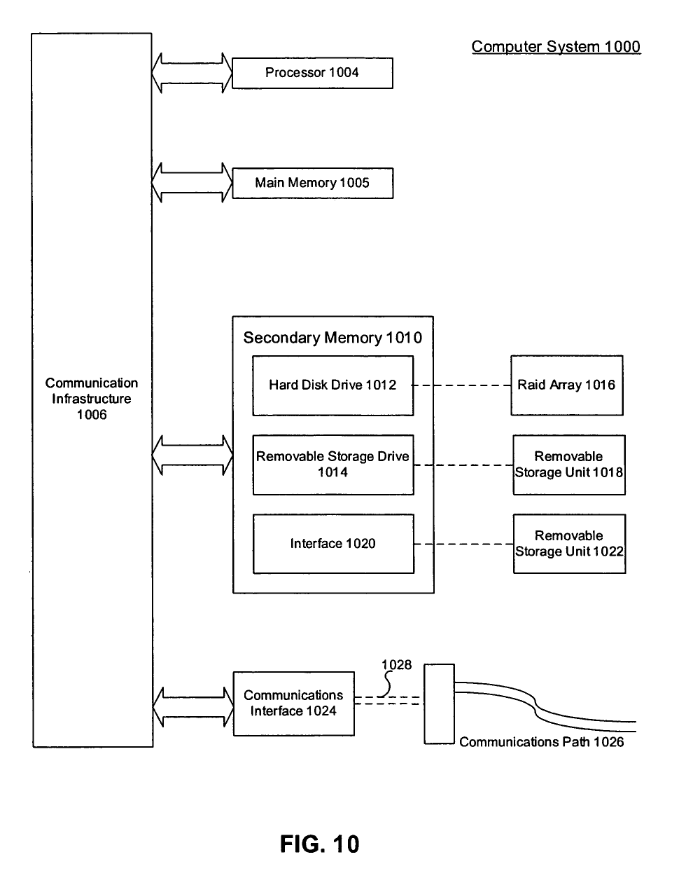

The following description of a general-purpose computer system is provided for completeness. The present invention can be implemented in hardware or as a combination of software and hardware. Consequently, the invention may be implemented in the environment of a computer system or other processing system. An example of such a computer system 1000 is shown in FIG. 10. The computer system 1000 includes one or more processors, such as processor 1004. Processor 1004 can be a special purpose or a general purpose digital signal processor. The processor 1004 is connected to a communication infrastructure 1006 (for example, a bus or network). Various software implementations are described in terms of this exemplary computer system. After reading this description, it will become apparent to a person skilled in the relevant art how to implement the invention using other computer systems and/or computer architectures.

Computer system 1000 also includes a main memory 1005, preferably random access memory (RAM), and may also include a secondary memory 1010. The secondary memory 1010 may include, for example, a hard disk drive 1012, and/or a RAID array 1016, and/or a removable storage drive 1014, representing a floppy disk drive, a magnetic tape drive, an optical disk drive, etc. The removable storage drive 1014 reads from and/or writes to a removable storage unit 1018 in a well known manner. Removable storage unit 1018, represents a floppy disk, magnetic tape, optical disk, etc. As will be appreciated, the removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

Computer system 1000 may also include a communications interface 1024. Communications interface 1024 allows software and data to be transferred between computer system 1000 and external devices. Examples of communications interface 1024 may include a modem, a network interface (such as an Ethernet card), a communications port, a PCMCIA slot and card, etc. Software and data transferred via communications interface 1024 are in the form of signals 1028 which may be electronic, electromagnetic, optical or other signals capable of being received by communications interface 1024. These signals 1028 are provided to communications interface 1024 via a communications path 1026. Communications path 1026 carries signals 1028 and may be implemented using wire or cable, fiber optics, a phone line, a cellular phone link, an RF link and other communications channels.

The terms “computer program medium” and “computer usable medium” are used herein to generally refer to media such as removable storage drive 1014, a hard disk installed in a disk drive enclosure 1012, and remotely located media accessed through a communications interface. These computer program products are means for providing software to computer system 1000.

Computer programs (also called computer control logic) are stored in main memory 1008 and/or secondary memory 1010. Computer programs may also be received via communications interface 1024. Such computer programs, when executed, enable the computer system 1000 to implement the present invention as discussed herein. In particular, the computer programs, when executed, enable the processor 1004 to implement the processes of the present invention. Where the invention is implemented using software, the software may be stored in a computer program product and loaded into computer system 1000 using raid array 1016, removable storage drive 1014, hard drive 1012 or communications interface 1024.

In another embodiment, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Thus, the breadth and scope of the present invention should not be limited by any of the above-described exemplary embodiments, but should be defined only in accordance with the following claims and their equivalents.

I claim:

1. A method for operating a computer system comprising:
(a). storing a digital representation of at least one hardware element; and
(b). displaying said digital representation to a user along with status information for said hardware element displayed proximate to said digital image, to indicate said hardware element status.

2. The method of claim 1, wherein a plurality of hardware elements in said computer system are included in the digital representation, and status information corresponding to each of said plurality of hardware elements is displayed in proximity to said corresponding digital representation in said software.

3. The method of claim 2 wherein said digital representation comprises one or more digital images of said plurality of hardware elements.

4. The method of claim 2, further comprising: configuring display locations for a plurality of status display elements in relationship to said digital representation of said hardware elements, and displaying said status display elements in said locations in said displaying step.

5. The method of claim 4, further comprising: interacting with said displayed status information to change status of at least one of said hardware elements.

6. The method of claim 5, further comprising: acquiring and storing one or more new digital representations when changing a physical configuration of hardware elements in the computer system.

7. The method of claim 6, further comprising: changing the display position of said status information in said software upon a change in location of a hardware element.

8. The method of claim 7, further comprising: formatting said digital representations to correspond to a physical arrangement of said hardware elements.

9. The method of claim 1, wherein said hardware element is a RAID array controlled by a RAID controller.

10. The method of claim 9, wherein said displaying step is performed by RAID controller software.
